(19) United States
(12) Patent Application Publication
(10) Pub. No.: US 2017/0289942 A1
(43) Pub. Date: Oct. 5, 2017

(54) RADIO TERMINAL, NETWORK APPARATUS, AND METHOD THEREFOR

(71) Applicant: NEC Corporation, Tokyo (JP)

(72) Inventor: Takanori IWAI, Tokyo (JP)

(21) Appl. No.: 15/623,508

(22) Filed: Jun. 15, 2017

Related U.S. Application Data
(62) Division of application No. 14/922,028, filed on Oct. 23, 2015.

(30) Foreign Application Priority Data
Oct. 24, 2014 (JP) 2014-217629

(51) Int. Cl. H04W 48/18; H04W 76/02; H04W 60/00

(52) U.S. Cl. CPC H04W 60/00

(57) ABSTRACT

A radio terminal establishes a control connection with a network, and receives, from the network, a selection policy used for selection of a core network entity that provides a mobility management service or a data transmission service for the radio terminal. Further, the radio terminal selects a target core network entity based on the selection policy, and transmits, to the network, a request message for requesting provision of the mobility management service or the data transmission service by the target core network entity.

### INCORPORATION BY REFERENCE

This application is based upon and claims the benefit of priority from Japanese patent application No. 2014-217629, filed on Oct. 24, 2014, the disclosure of which is incorporated herein in its entirety by reference.

### BACKGROUND OF THE INVENTION

### 1. Technical Field

The present disclosure relates to a mobile communication network, in particular, to mobility management for radio terminals.

### 2. Background Art

US 2013/0301540 A1 discloses that a base station (evolved Node B (eNB)) receives an attach request from a radio terminal, determines whether the radio terminal is a stationary device, and establishes a connection between the radio terminal and a network by using a local component associated with the base station (eNB) when the radio terminal is a stationary device. Note that the local component can perform at least one of a plurality of functions provided by a remote mobility management entity (MME), a remote serving gateway (S-GW), and a remote packet data network (PDN) gateway (P-GW). The remote MME, the remote S-GW, and the remote P-GW are arranged in an evolved packet core (EPC) network. In one example, the attach request includes an indicator indicating whether the radio terminal is a stationary device or not and the base station (eNB) determines whether the radio terminal is a stationary device or not based on this indicator.

In another example disclosed in US 2013/0301540 A1, a home subscriber server (HSS) arranged in the EPC network determines whether the radio terminal is a stationary device or not based on subscriber information of the radio terminal. The base station (eNB) sends the attach request to the HSS through an MME device, receives a response from the HSS through the MME device, and determines whether the radio terminal is a stationary device or not based on the response from the HSS. To establish a connection between the radio terminal and the network, the base station (eNB) uses a local component (e.g., a local MME component) when the radio terminal is a stationary device. Further, when the radio terminal is a mobile device, the base station (eNB) uses a remote MME, a remote S-GW, and a remote P-GW.

As described above, US 2013/0301540 A1 discloses that the base station (eNB) or the HSS determines whether a radio terminal is a stationary device or not, and a connection for the radio terminal is established by using a local component (e.g., local MME component) associated with that base station when the radio terminal is a stationary device.

However, in some cases, it may be unreasonable that the base station (eNB) or the HSS determines whether the local component, associated with the base station (eNB), is used for establishing a connection with a radio terminal or not. For example, the mobility of a radio terminal is not permanently fixed and may change depending on the time. In the technique disclosed in US 2013/0301540 A1, it could be difficult to switch from a local component arranged in the radio access network to the remote device arranged in the core network, or vice versa, according to the mobility of the radio terminal that dynamically changes. Further, the situation where the use of a local component, instead of a remote device, is appropriate is not limited to the cases where the radio terminal is a stationary device. For example, other parameters such as the frequency of occurrence of communications performed by the radio terminal (i.e., how often the radio terminal communicates) and the delay tolerance level of the radio terminal could be used for the determination whether the local component is used or not. The frequency of occurrence of communications performed by the radio terminal and the delay tolerance level of the radio terminal are also not permanently (statically) fixed, and, for example, they may dynamically change depending which application (e.g., a web browser application, a text messaging application, a voice call application, or an online game application) is being used in the radio terminal.

### SUMMARY

An object intended to be achieved by embodiments disclosed in this specification is to provide an apparatus, a method, and a program that make it easier to determine which of a plurality of core network entities (e.g., a remote MME device arranged in a core network and a local MME component associated with a radio access network (e.g., a base station)) should be used for a radio terminal according to a state of the radio terminal that dynamically changes. It should be noted that the above-described object is merely one of objects intended to be achieved by embodiments disclosed in this specification. Other objects or problem to be solved and novel features will be more apparent from the following descriptions of this specification and the accompanying drawings.

In a first aspect, a radio terminal includes a memory and at least one processor coupled to the memory. The at least one processor operates: (a) to establish a control connection with a network; (b) to receive, from the network, a selection policy used for selection of a core network entity that provides a mobility management service or a data transmission service for the radio terminal, (c) to select a target core network entity based on the selection policy, and (d) to transmit, to the network, a request message for requesting provision of the mobility management service or the data transmission service by the target core network entity.

In a second aspect, a network apparatus includes a memory and at least one processor coupled to the memory. The at least one processor operates to receive from a radio terminal a change request for a core network entity, in which the change request explicitly indicates a target core network entity determined by the radio terminal. The at least one processor further operates, in response to the change request, to communicate with a serving core network entity that is currently providing a mobility management service or a data transmission service for the radio terminal to transfer the mobility management service or the data transmission service from the serving core network entity to a target core network entity.

In a third aspect, a method performed by a radio terminal, includes: (a) establishing a control connection with a network; (b) receiving, from the network, a selection policy used for selection of a core network entity that provides a mobility management service or a data transmission service for the radio terminal, (c) selecting a target core network entity based on the selection policy, and (d) transmitting, to the network, a request message for requesting provision of the mobility management service or the data transmission service by the target core network entity.

In a fourth aspect, a method performed by a network apparatus, includes: (a) receiving from a radio terminal a change request for a core network entity, in which the change request explicitly indicates a target core network entity determined by the radio terminal, and (b) in response to the change request, communicating with a serving core network entity that is currently providing a mobility management service or a data transmission service for the radio terminal to transfer the mobility management service or the data transmission service from the serving core network entity to the target core network entity.

In a fifth aspect, a program includes instructions (software code) for, when loaded into a computer, causing the computer to perform a method according to the above-described third or fourth aspect.

### BRIEF DESCRIPTION OF THE DRAWINGS

The above and other aspects, features, and advantages of the present invention will become more apparent from the following description of certain embodiments when taken in conjunction with the accompanying drawings, in which:

FIG. 1 shows a configuration example of a mobile communication network according to some embodiments;

FIG. 2 is a flowchart showing an example of a process for an MME change performed by a radio terminal according to a first embodiment;

FIG. 3 is a flowchart showing an example of a process for an MME change performed by a target MME according to the first embodiment;

FIG. 4 is a sequence diagram showing an example of an MME change procedure according to a second embodiment;

FIG. 5 is a sequence diagram showing an example of a mobility management relocation procedure according to the second embodiment;

FIG. 6 is a sequence diagram showing an example of an MME change procedure according to a third embodiment;

FIG. 7 is a sequence diagram showing an example of an MME change procedure according to the third embodiment;

FIG. 8 shows a configuration example of a mobile communication network according to some embodiments;

FIG. 9 is a flowchart showing an example of a process for a core network entity change on a user plane performed by a radio terminal according to a fourth embodiment;

FIG. 10 is a flowchart showing an example of a process for a core network entity change on a user plane performed by a serving MME according to the fourth embodiment;

FIG. 11 is a block diagram showing a configuration example of a radio terminal according to some embodiments; and

FIG. 12 is a block diagram showing a configuration example of an MME according to some embodiments.

### EXEMPLARY EMBODIMENT

Specific embodiments are explained hereinafter in detail with reference to the drawings. The same symbols are assigned to the same or corresponding elements throughout the drawings, and duplicated explanations are omitted as necessary.

Embodiments described below will be explained mainly using specific examples with regard to an Evolved Packet System (EPS), i.e., to a Long Term Evolution (LTE) system or an LTE-Advanced system. However, these embodiments are not limited to the EPS, and they may be applied to other mobile communication networks or systems such as a 3GPP Universal Mobile Telecommunications System (UMTS), a 3GPP2 CDMA2000 system, a Global System for Mobile communications (GSM)/General packet radio service (GPRS) system, and a WiMAX system.

### First Embodiment

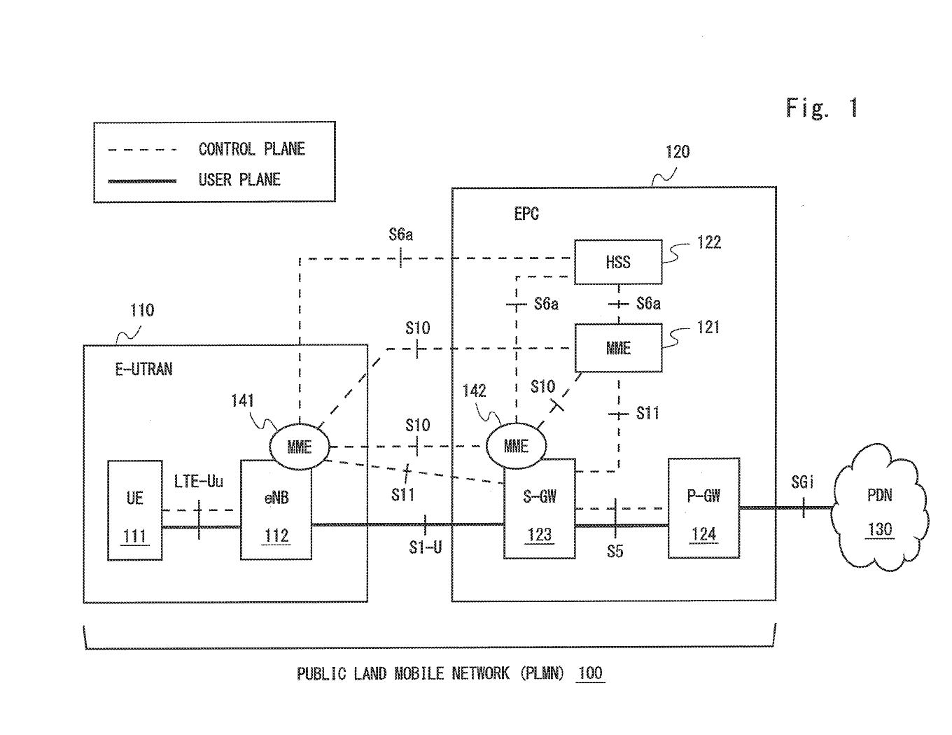

FIG. 1 shows a configuration example of a Public Land Mobile Network (PLMN) 100 according to this embodiment. The PLMN 100 provides a communication service, for example, a voice communication service, a packet data communication service, or both of them to a radio terminal (User Equipment (UE)) 111. The PLMN 100 includes a radio access network (Evolved Universal Terrestrial Radio Access Network (E-UTRAN)) 110 and a core network (Evolved Packet Core (EPC)) 120. The E-UTRAN 110 includes a base station (eNB) 112 that wirelessly communicates with the UE 111. The EPC 120 includes a Mobility Management Entity (MME) device 121, a Home Subscriber Server (HSS) 122, a Serving Gateway (S-GW) 123, and a PDN Gateway (P-GW) 124.

For simplification of the illustration, FIG. 1 shows only one eNB 112, one S-GW 123, and one P-GW 124. However, the PLMN 100 may include a plurality of eNBs 112, a plurality of S-GWs 123, and a plurality of P-GWs 124. The MME device 121 and the HSS 122 may communicate with a plurality of eNBs, a plurality of S-GWs, and a plurality of P-GWs. The PLMN 100 may further include a plurality of MME devices 121 and a plurality of HSSs 122.

Each of the MME and the HSS 122 is a control plane node or entity arranged in the EPC 120. The MME can perform mobility management and bearer management for a plurality of UEs including the UE 111. The mobility management is used to keep track of the current position of the UE and includes maintaining a mobility management (MM) context related to the UE. The bearer management includes controlling establishment of an EPS bearer for enabling the UE to communicate with an external network (Packet Data Network (PDN)) 130 through the E-UTRAN 110 and the EPC 120, and maintaining a bearer management context (i.e., EPS bearer context) related to the UE. The HSS 122 manages subscriber information of UEs including the UE 111.

Each of the S-GW 123 and the P-GW 124 is a user plane packet transmission node arranged in the EPC 120 and transfers user data (i.e., Internet Protocol (IP) packets). The S-GW 123 is a gateway to the E-UTRAN 110 and is connected to the eNB 112 through an S1-U interface. The P-GW 124 is a gateway to the PDN 130 and is connected to the PDN 130 through an SGi interface. The PDN 130 may be an external network such as the Internet or may be a network for an IP service (e.g., IP Multimedia Subsystem (IMS) service) provided by an operator managing the EPC 120.

An MME component 141 is associated with the eNB 112 and arranged remotely from the MME device 121 arranged in the EPC 120. The MME component 141 may be arranged integrally with the eNB 112. The MME component 141 may be arranged in the same geographical location as that of the eNB 112 or may be arranged in the same cell site as that of the eNB 112. The MME component 141 can perform at least one of a plurality of functions related to the mobility management and the bearer management provided by the MME device 121. For example, the MME component 141 may perform the tracking of UE 111. In other words, the MME component 141 may perform a location update procedure (i.e., Tracking Area Update (TAU) procedure) for the UE 111. Further or alternatively, the MME component 141 may establish an EPS bearer for the UE 111. In other words, the MME component 141 may perform a bearer establishment procedure (i.e., Service Request procedure) for the UE 111. Further or alternatively, the MME component 141 may perform the paging of the UE 111.

An MME component 142 is associated with the S-GW 123 and arranged remotely from the MME device 121 arranged in the EPC 120. The MME component 142 may be arranged integrally with the S-GW 123. The MME component 142 may be arranged in the same geographical location as that of the S-GW 123 or may be arranged in the same cell site as that of the S-GW 123. Similarly to the MME component 141, the MME component 142 can perform at least one of a plurality of functions related to the mobility management and the bearer management provided by the MME device 121.

The MME component 141 is arranged remotely from the MME device 121, and hence the route cost between the UE 111 and the MME component 141 differs from that between the UE 111 and the MME device 121. Further, the MME component 141 is arranged remotely from the MME component 142, and hence the route cost between the UE 111 and the MME component 141 differs from that between the UE 111 and the MME component 142. Note that the route cost is a cost necessary for a control message (e.g., a data packet) transmitted from the UE 111 to arrive at the MME component 141 (or vice versa) and can be defined by using various metrics. The route cost depends on, for example, a processing time in processing devices, such as an eNB, located between the UE 111 and the MME component 141, a processing time of packet transmission devices such as a router and a switch, and the transmission rate of communication lines between these devices. For example, the route cost may be defined by using the number of hops (the number of relay nodes) from the UE 111 to the MME component 141. A large hop number means a large route cost. For example, the route cost may be defined by using a delay time from the UE 111 to the MME component 141 or a Round Trip Time (RTT). A large delay time or a large RTT means a large route cost. Further, the route cost may be defined a plurality of metrics, e.g., the number of hops and the delay time. The route cost is also called “distance”.

The MME component 141 associated with the eNB 112, the MME component 142 associated with the S-GW 123, and the MME device 121 arranged in the EPC 120 may be differentiated according to the sizes of their management ranges. In one example, the MME component 141 is used for the mobility management for UEs located in one or more cells managed by the eNB 112, and therefore its management range is relatively narrow. In one example, the MME component 142 is used for the mobility management for UEs located in a plurality of cells managed by a plurality of eNBs 112 connected to the S-GW 123, and therefore its management range has an intermediate size. In one example, the MME device 121 is used for the mobility management for UEs located in a number of cells managed by a number of eNBs 112 connected to a plurality of S-GWs 123, and therefore its management range is larger than those of the MME components 141 and 142.

An MME component that is arranged in association with a network node such as the eNB 112 and the S-GW 123 may be assigned an IP address different from the IP address of the network node with which the MME component is associated in order to differentiate that MME component from the network node. Alternatively, the MME component and the network node with which the MME component is associated use a common IP address, and they may be differentiated based on different Transmission Control Protocol (TCP) port numbers or different User Datagram Protocol (UDP) port numbers.

The UE 111 according to this embodiment performs the following operations to select an MME that performs the mobility management for the UE 111. The UE 111 establishes a control connection with a serving MME (e.g., the MME device 121) arranged in a network including the PLMN 100 and receives an MME selection policy from the PLMN 100 (e.g., the MME device 121, the HSS 122, the eNB 112, or a control server arranged in the PDN 130). Further, the UE 111 selects a target MME based on the MME selection policy and transmits, to the network (e.g., the serving MME or the target MME), a request message for requesting transfer of the mobility management for the UE 111 from the serving MME to the target MME.

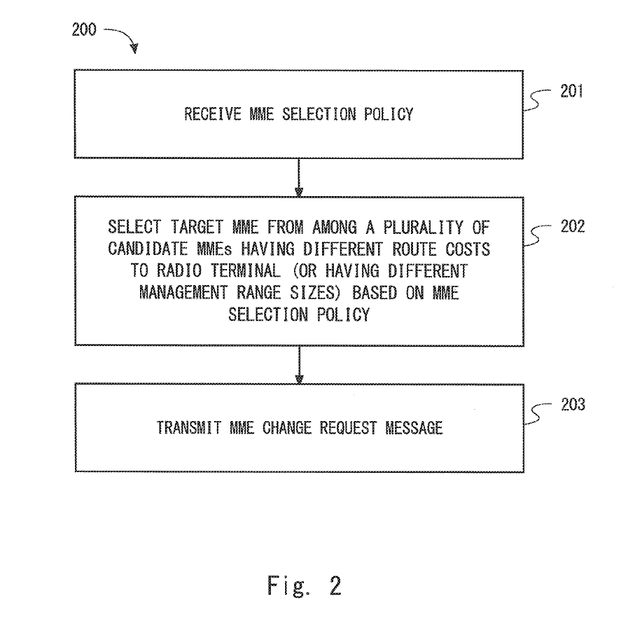

FIG. 2 is a flowchart showing a process 200 that is an example of a process performed by the UE 111. In a block 201, the UE 111 receives an MME selection policy. The UE 111 may receive the MME selection policy from the MME device 121, the HSS 122, or the eNB 112. The UE 111 may receive the MME selection policy from a control server arranged in the PDN 130 on the user plane through the PLMN 100. In one example, the MME selection policy indicates one or more parameters that should be taken into account for the MME selection. The parameter(s) that should be taken into account for the MME selection may include a parameter(s) related to at least one of a delay tolerance level of the UE 111, a frequency of occurrence of control signaling performed by the UE 111 (i.e., how often control signaling is performed), a mobility characteristic of the UE 111, and a communication interval of the UE 111. The parameter(s) that should be taken into account for the MME selection may include load information of the network node (e.g., the eNB 112, the MME device 121, the HSS 122, and the S-GW 123). Further or alternatively, the MME selection policy may designate a selection algorithm. Specifically, the MME selection policy may indicate (a) a parameter(s) to be taken into account, (b) a threshold, (c) an identifier of an MME (e.g., the MME component 141) that should be selected when the parameter exceeds the threshold, and (d) an identifier of an MME (e.g., the MME device 121 or the MME component 142) that should be selected when the parameter does not exceed the threshold. Further or alternatively, the MME selection policy may indicate a timing at which the MME selection is performed or a cycle in which the MME selection is periodically performed.

In a block 202, based on the MME selection policy, the UE 111 selects a target MME from among a plurality of candidate MMEs which have different route costs to the UE 111 or have different sizes of the management range. To detect a plurality of candidate MMEs, the UE 111 may communicate with nodes/entities arranged in the E-UTRAN 110 and the EPC 120. Alternatively, the UE 111 may receive a list of candidate MMEs from the serving MME or the eNB 112. The plurality of candidate MMEs include, for example, the MME component 141 associated with the eNB 112 and the MME device 121 arranged in the EPC 120. The plurality of candidate MMEs may further include the MME component 142 associated with the S-GW 123. In general, the MME component 141 associated with the eNB 112 has a smaller route cost and a narrower management range than those of the MME device 121 and the MME component 142 arranged in the EPC 120.

The UE 111 may perform the MME selection as follows. In one implementation, when the mobility of the UE 111 is lower than a threshold, the UE 111 may select an MME having a route cost (or a management range) smaller (or narrower) than that of the MME device 121 as a target MME. For example, the UE 111 may select the MME component 141 associated with the E-UTRAN 110 (e.g., the eNB 112) as a target MME. If the mobility of the UE 111 is high, selecting the MME component 141 associated with the E-UTRAN 110 could lead to frequent changes of MMEs and hence an increase in the number of control signaling processes. In contrast to this, if the mobility of the UE 111 is low, it can be expected that the increase in the signaling cost caused by frequent changes of MMEs is small. Therefore, when the mobility of the UE 111 is small, selecting the MME component 141 associated with the E-UTRAN 110 can reduce the delay time necessary for the control signaling process, while preventing the increase in the signaling cost caused by frequent changes of MMEs. The level of the mobility of the UE 111 may be evaluated, for example, by using an average time of stay in a cell, a frequency of occurrence of handovers (i.e., how often handovers are performed), or an average interval of occurrence of handovers.

In one implementation, when the delay tolerance level of the UE 111 is lower than a threshold (i.e., when the UE 111 cannot tolerate delay), the UE 111 may select an MME having a route cost (or a management range) smaller (or narrower) than that of the MME device 121 as a target MME. For example, the UE 111 may select the MME component 141 associated with the E-UTRAN 110 (e.g., the eNB 112) as a target MME. As a result, the delay time necessary for processing of the control signaling can be reduced.

In one implementation, when the response time (e.g., a Round Trip Time (RTT)) of the serving MME (e.g., the MME device 121) exceeds a threshold, the UE 111 may select an MME (e.g., the MME component 141) having a route cost (or a management range) smaller (or narrower) than that of the serving MME as a target MME. The threshold used in this process may be determined based on the delay tolerance level of the UE 111 in such a manner that the smaller the delay tolerance level of the UE 111 is, the lower the threshold is set.

In one implementation, when the frequency of occurrence of control signaling performed by the UE 111 exceeds a threshold, the UE 111 may select an MME having a route cost (or a management range) smaller (or narrower) than that of the MME device 121 as a target MME. For example, the UE 111 may select the MME component 141 associated with the E-UTRAN 110 (e.g., the eNB 112) as a target MME. As a result, it is possible to mitigate an increase of a load on a control plane (e.g., a communication device and a communication line) caused by frequent occurrences of signaling between the E-UTRAN 110 and the EPC 120.

In one implementation, when the communication interval of the UE 111 is lower than the threshold (i.e., the communication interval of the UE 111 is short), the UE 111 may select an MME having a route cost (or a management range) smaller (or narrower) than that of the MME device 121 as a target MME. For example, the UE 111 may select the MME component 141 associated with the E-UTRAN 110 (e.g., the eNB 112) as a target MME. As a result, it is possible to mitigate an increase of a load on a control plane (e.g., a communication device and a communication line) caused by frequent occurrences of signaling between the E-UTRAN 110 and the EPC 120.

In one implementation, the UE 111 may select an MME while taking a load on a network node into consideration. For example, when the load on the serving MME (e.g., the MME device 121) exceeds a threshold, the UE 111 may select an MME device or an MME component having a load smaller than that of the serving MME as a target MME. Alternatively, the UE 111 may refer to the load states of a plurality of MMEs (e.g., the MME device 121, the MME component 141, and the MME component 142) and select a target MME so that the load for the mobility management is distributed over the plurality of the MMEs. The above-described plurality of examples of the MME selection based on different parameters may be combined as appropriate.

In the above-described examples of the MME selection, the UE 111 itself may measure a parameter used for the MME selection (e.g., the response time (e.g., RTT) of the network node, the load of the network node, or the route cost (e.g., the number of hops, the delay time, or the distance)). For example, the UE 111 may measure the time from when the UE 111 transmits a control message to when the UE 111 receives its response message in order to measure the response time (RTT) or the route cost. The UE 111 may use “ping” or “traceroute” defined in the Internet Control Message Protocol (ICMP) in order to measure the response time (RTT) or the route cost. Alternatively, the UE 111 may receive a parameter value(s) used for the MME selection that is/are measured in one or more network nodes arranged in the E-UTRAN 110 or the EPC 120 from these network nodes. Alternatively, the UE 111 may receive the parameter value(s) from a control node arranged outside the PLMN 100. The control node may be a Software-Defined Network (SDN) controller, a Network Function Virtualization (NFV) controller, an Operations Support System (OSS), or an Element Management System (EMS).

The explanation is now continued with reference to FIG. 2. In a block 203, the UE 111 transmits an MME change request message. The UE 111 may transmit the MME change request message to a serving MME that is currently performing the mobility management for the UE 111 (e.g., the MME device 121), or may transmit the MME change request message to the target MME selected in the block 202 (e.g., the MME component 141).

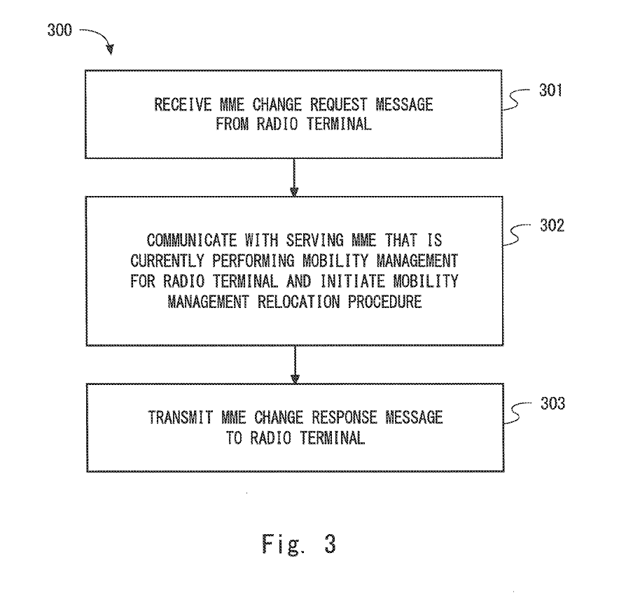

FIG. 3 is a flowchart showing a process 300 that is an example of an operation that is performed by the target MME when the target MME receives an MME change request message. In a block 301, the target MME (e.g., the MME component 141) receives the MME change request message from the UE 111. In a block 302, the target MME communicates with the serving MME that is currently performing the mobility management for the UE 111 (e.g., the MME device 121) and initiates a relocation procedure for transferring the mobility management for the UE 111 from the serving MME to the target MME. In a block 303, upon completing the relocation procedure, the target MME transmits an MME change response message to the UE 111.

As can be understood from the above explanation, in this embodiment, the MME selection is carried out in the UE 111. Accordingly, in this embodiment, the MME selection can be easily performed according to the state of the UE 111 that dynamically changes (e.g., the delay tolerance level, the mobility characteristic, the occurrence frequency of signaling, or the communication interval).

Further, in this embodiment, the UE 111 operates to receive the MME selection policy from the network (e.g., the MME device 121, the HSS 122, or the eNB 112). Therefore, the MME selection policy can be determined in the network, thus making it possible to set an MME selection policy that is determined according to the state of the network (e.g., the load on the MME and the occurrence/non-occurrence of congestion) in the UE 111.

### Second Embodiment

In this embodiment, a specific example of the MME change procedure explained in the first embodiment is explained. The configuration example of a mobile communication network according to this embodiment may be to the same as the configuration that is explained above in the first embodiment and shown in FIG. 1.

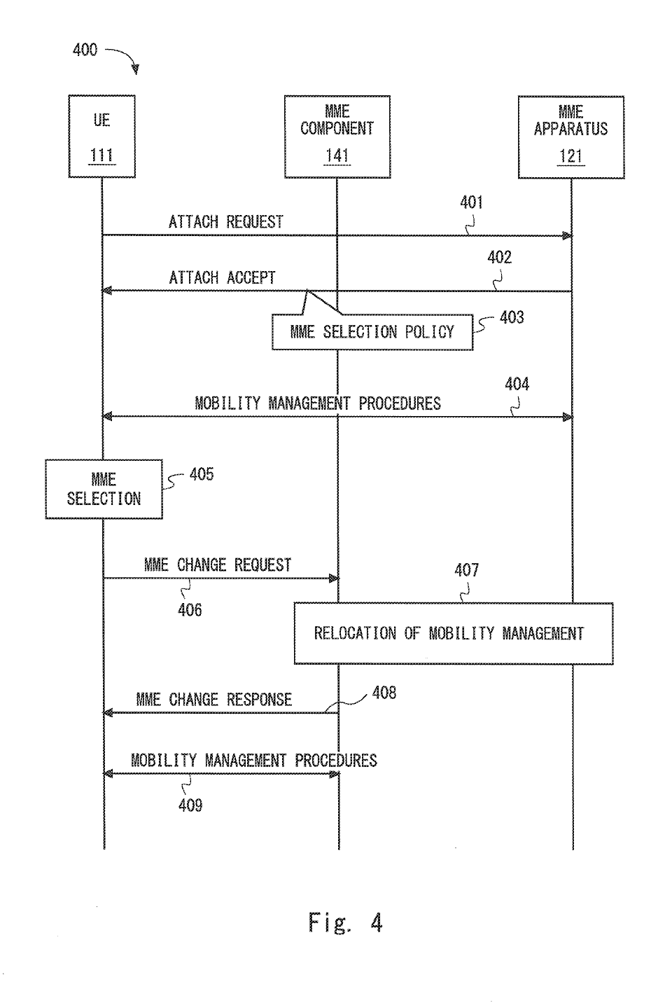

FIG. 4 is a sequence diagram showing a process 400 that is an example of an MME change procedure according to this embodiment. In the example shown in FIG. 4, the MME device 121, which serves as a serving MME, transmits an MME selection policy to the UE 111. The UE 111 selects the MME component 141 associated with the eNB 112 as a target MME based on the MME selection policy and transmits an MME change request message to the target MME.

In a block 401, the UE 111 transmits an Attach Request message to the MME device 121. Note that the MME selection in the block 401 may be performed by an MME selecting function within the eNB 112 that has received the Attach Request. In a block 402, the MME device 121, which serves as the serving MME, transmits an Attach Accept message to the UE 111. This Attach Accept message includes the MME selection policy. Alternatively, the MME selection policy may be transmitted by using another Non-Access Stratum NAS) message (e.g., a TAU Accept message) instead of the Attach Accept message. The MME selection policy may be transmitted from the serving MME (the MME device 121) to the UE 111 during a procedure different from the attach procedure (blocks 401 and 402), for example, in a TAU procedure. In a block 404, a mobility management procedure (e.g., a TAU procedure, a Service Request procedure, and paging) is performed between the UE 111 and the MME device 121 (serving MME).

In a block 405, the UE 111 selects an MME suitable for performing the mobility management for the UE 111 (i.e., a target MME) based on the MME selection policy. In the example shown in FIG. 4, the MME component 141 associated with the eNB 112 is selected as the target MME. In a block 406, the UE 111 transmits an MME change request message to the MME component 141 (target MME). In a block 407, in response to the reception of the MME change request message, the MME component 141 initiates a control procedure for transferring the mobility management for the UE 111 from the MME device 121 (serving MME) to the MME component 141 (target MME). In a block 408, the MME component 141 transmits an MME change response message to the UE 111. In a block 409, a mobility management procedure is performed between the UE 111 and the MME component 141 (target MME, i.e., a new serving MME).

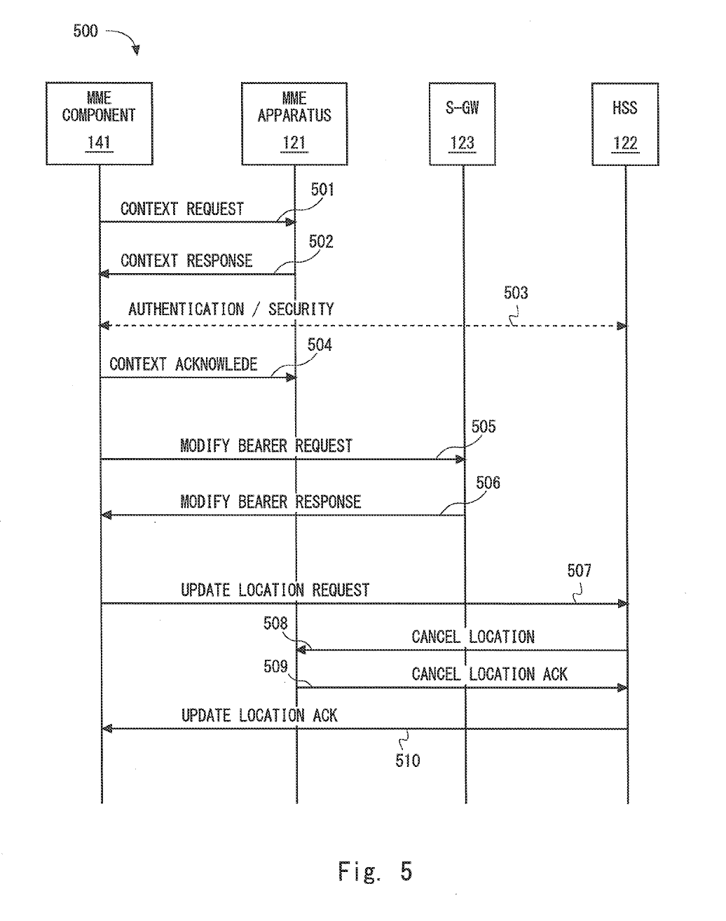

The control procedure for transferring the mobility management for the UE 111 (block 407) may be similar to the procedure for transferring the mobility management from an old MME to a new MME performed during the TAU procedure that is performed when the UE 111 detects that it enters a new TA (Tracking Area). FIG. 5 is a sequence diagram showing a process 500 that is a specific example of the control procedure (block 407). In a block 501, the MME component 141 (target MME) transmits a Context Request message to the MME device 121 (serving MME). In a block 502, the MME device 121 transmits to the MME component 141 a Context Response message including a context (MM context and EPS bearer context) of the UE 111. In a block 503, the MME component 141 communicates with the HSS 122 and the UE 111 (not shown) for the authentication and the security setup of the UE 111. When the authentication and the security setup of the UE 111 have been effective, the block 503 may be omitted. In a block 504, the MME component 141 transmits a Context Acknowledge message to the MME device 121.

In a block 505, the MME component 141 transmits a Modify Bearer Request message to the S-GW 123 in order to inform the S-GW 123 of the address of the new MME (i.e., the MME component 141). The Modify Bearer Request message indicates an IP address and an MME TEID of the new MME that manages the EPS bearer of the UE 111, i.e., the MME component 141. In a block 506, the S-GW 123 transmits a Modify Bearer Response message to the MME component 141.

Blocks 507 to 510 are performed in order to inform the HSS 122 of the MME change. Note that it is also possible to inform the HSS 122 of the MME change in an ordinary TAU procedure that is performed after completion of the MME relocation procedure (500). Accordingly, the processes in the blocks 507 to 510 may be omitted. In the block 507, the MME component 141 transmits an Update Location Request message to the HSS 122. The Update Location Request message indicates an identifier of the MME component 141. In a block 508, the HSS 122 transmits a Cancel Location message to the MME device 121 to inform the MME device 121 that the context related to the UE 111 (MM context and EPS bearer context) can be released. In a block 509, the MME device 121 releases, if necessary, the context related to the UE 111, and the MME device 121 transmits a Cancel Location Ack message to the HSS 122. In a block 510, the HSS 122 acknowledges the Update Location Request by transmitting an Update Location Ack message to the MME component 141.

According to the control procedure explained in this embodiment, the MME selection can be carried out in the UE 111. Accordingly, the MME selection can be easily performed according to the dynamically changing state of the UE 111 (e.g., the delay tolerance level, the mobility characteristic, the occurrence frequency of signaling, or the communication interval).

Further, in the control procedure explained in this embodiment, the UE 111 operates to receive the MME selection policy from the network (e.g., the MME device 121). Therefore, the MME selection policy can be determined in the network, thus making it possible to set an MME selection policy that is determined according to the state of the network (e.g., the load on the MME and the occurrence/non-occurrence of congestion) in the UE 111.

### Third Embodiment

In this embodiment, a specific example of the MME change procedure explained in the first embodiment is explained. The configuration example of a mobile communication network according to this embodiment may be to the same as the configuration that is explained above in the first embodiment and shown in FIG. 1.

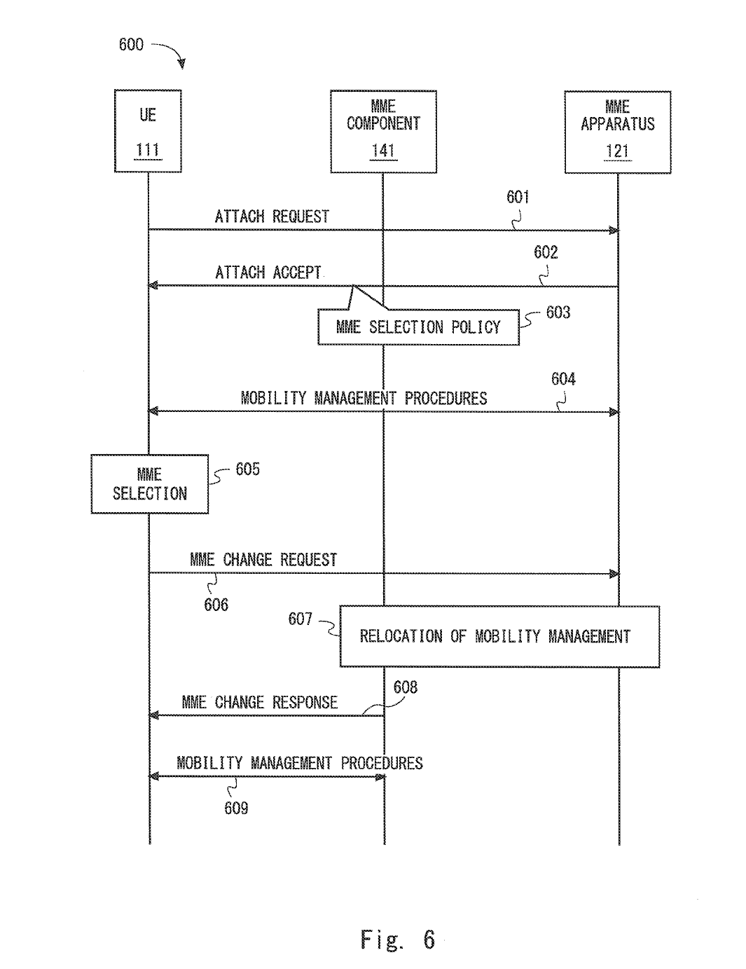

FIG. 6 is a sequence diagram showing a process 600 that is an example of an MME change procedure according to this embodiment. In the example shown in FIG. 6, the MME device 121, which serves as a serving MME, transmits an MME selection policy to the UE 111. The UE 111 selects the MME component 141, which is associated with the eNB 112, as a target MME based on the MME selection policy and transmits to the MME device 121 (source MME) an MME change request message for requesting the transfer of the mobility management to the MME component 141 (target MME).

Processes in blocks 601 to 605 in FIG. 6 are similar to those in blocks 401 to 405 in FIG. 4. In a block 606, the UE 111 transmits an MME change request message to the MME device 121 (source MME). In a block 607, in response to the reception of the MME change request message, the MME device 121 initiates a control procedure for transferring the mobility management for the UE 111 from the MME device 121 (serving MME) to the MME component 141 (target MME). In a block 608, the MME component 141 transmits an MME change response message to the UE 111. The MME change response message (608) may be transmitted from the MME device 121 to the UE 111. In a block 609, a mobility management procedure is performed between the UE 111 and the MME component 141 (target MME, i.e., a new serving MME).

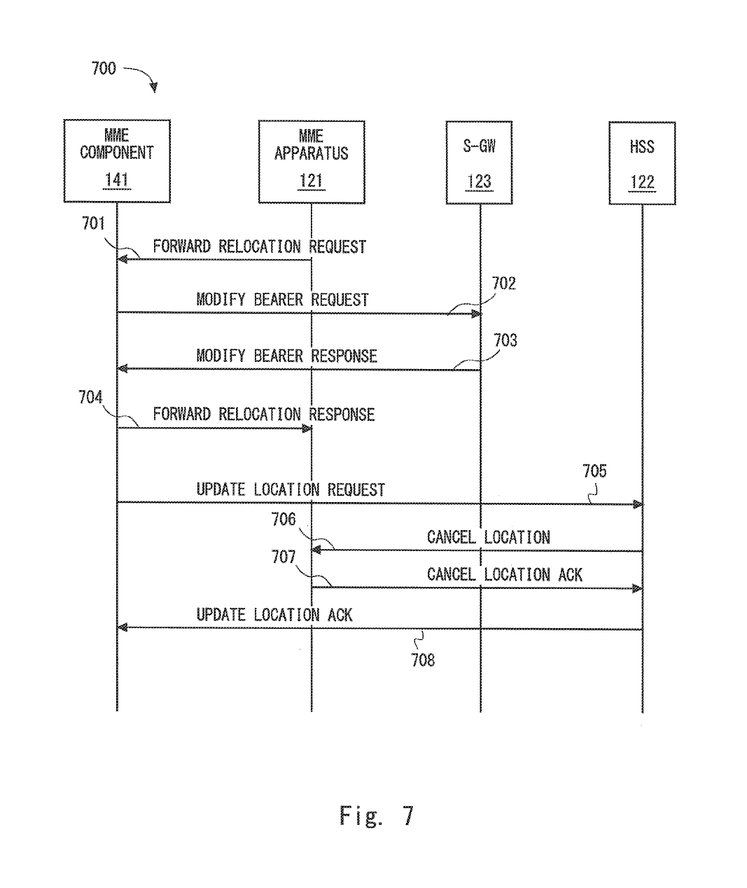

The control procedure for transferring the mobility management for the UE 111 (block 607) is similar to the procedure for transmitting a UE context from a source MME to a target MME by using a Forward Relocation Request message that is performed during the S1-based handover. FIG. 7 is a sequence diagram showing a process 700 that is a specific example of the control procedure (block 607).

In a block 701, the MME device 121 (serving MME) transmits a context (MM context and EPS bearer context) of the UE 111 to the MME component 141 (target MME). For this transmission, a GPRS Tunnelling Protocol for the Control Plane (GTP-C) message, which is used in an S10 interface between MMEs, can be used. Specifically, as shown in FIG. 7, a Forward Relocation Request message or a message modified therefrom may be used. The Forward Relocation Request message in the block 701 may include an information element indicating that the message is not a message transmitted for an S1-based handover but is a message transmitted for a Context Relocation.

In a block 702, the MME component 141 stores the context of the UE 111 received from the MME device 121 into its own memory or storage (not shown). The MME component 141 requests the S-GW 123 to update an EPS bearer context of the UE 111 held in the S-GW 123. Processes in blocks 702 and 703 are similar to those in blocks 501 and 506 in FIG. 5. In a block 704, the MME component 141 notifies the MME device 121 of acceptance of the taking-over of the mobility management and the bearer management for the UE 111. For the transmission of this notification, a GTP-C message, which is used in an S10 interface between MMEs, can be used. Specifically, as shown in FIG. 7, a Forward Relocation Response message or a message modified therefrom may be used.

Processes in blocks 705 to 708 are performed in order to notify the HSS 122 of the MME change. Processes in blocks 705 to 708 are similar to those in blocks 507 to 510 in FIG. 5.

According to the control procedure explained in this embodiment, the MME selection can be carried out in the UE 111. Accordingly, the MME selection can be easily performed according to the dynamically changing state of the UE 111 (e.g., the delay tolerance level, the mobility characteristic, the occurrence frequency of signaling, or the communication interval).

Further, in the control procedure explained in this embodiment, the UE 111 operates to receive the MME selection policy from the network (e.g., the MME device 121). Therefore, the MME selection policy can be determined in the network, thus making it possible to set an MME selection policy that is determined according to the state of the network (e.g., the load on the MME and the occurrence/non-occurrence of congestion) in the UE 111.

### Fourth Embodiment

In the first to third embodiments, examples of the MME selection are explained. The technical idea explained in the first to third embodiments can be applied to a selection of a core network entity (e.g., an S-GW, a P-GW, or both of them) on a user plane that provides a data transmission service to the UE 111. In this embodiment, an example in which the UE 111 selects a core network entity on a user plane (hereinafter called “core network user plane entity”) is explained.

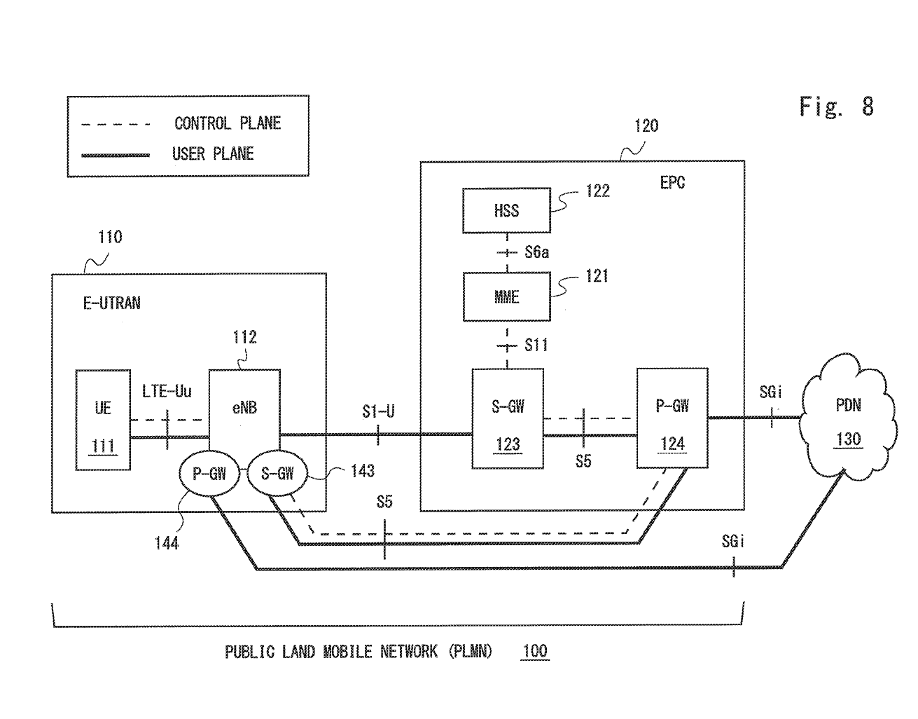

FIG. 8 shows a configuration example of a Public Land Mobile Network (PLMN) 100 according to this embodiment. In the example shown in FIG. 8, the PLMN 100 includes an S-GW component 143 and a P-GW component 144 that are arranged in association with an eNB 112.

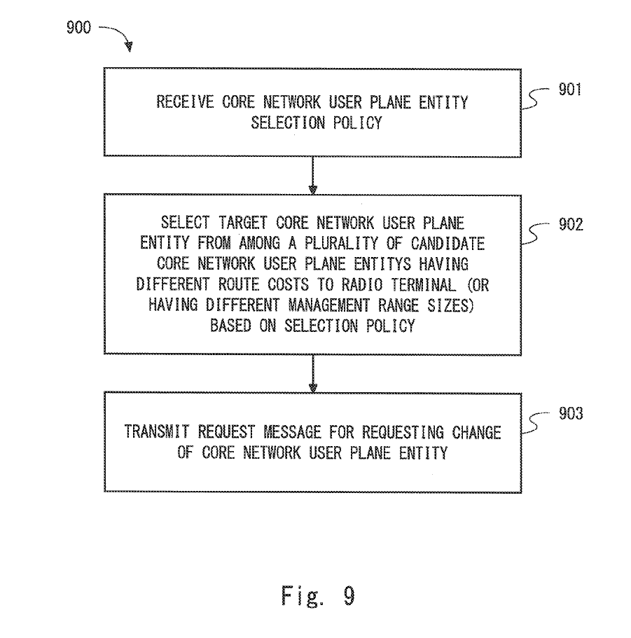

An UE 111 according to this embodiment selects either or both of an S-GW and a P-GW, which provide a data transmission service to the UE 111. FIG. 9 is a flowchart showing a process 900 that is an example of a process performed by the UE 111. In a block 901, the UE 111 receives a selection policy for selecting a core network user plane entity. The UE 111 may receive the selection policy from the MME device 121, the HSS 122, or the eNB 112. The UE 111 may receive the selection policy on the user plane through the PLMN 100 from a control server arranged in a PDN 130. The selection policy indicates one or more parameters that should be taken into account for selecting a core network user plane entity. Similarly to the MME selection policy explained in the first embodiment, the selection policy may indicate a parameter(s) related to at least one of the delay tolerance level of the UE 111, the frequency of occurrence of control signaling performed by the UE 111, the mobility characteristic of the UE 111, and the communication interval of the UE 111, The selection policy may indicate a parameter(s) related to a load(s) of a network node(s) (e.g., the eNB 112, the MME device 121, the HSS 122, and the S-GW 123). Further or alternatively, the selection policy may designate a selection algorithm. Further or alternatively, the selection policy may indicate a timing at which the selection of the core network user plane entity is performed or a cycle in which the selection of the core network user plane entity is periodically performed.

In a block 902, based on the selection policy, the UE 111 selects a target core network entity from among a plurality of candidate core network entities which have different route costs to the UE 111 or have different sizes of the management range. To detect a plurality of candidate core network entities, the UE 111 may communicate with nodes/entities arranged in the E-UTRAN 110 and the EPC 120. Alternatively, the UE 111 may receive a list of candidate core network entities from the serving MME or the eNB 112. The plurality of candidate core network entities include, for example, the S-GW component 143 associated with the eNB 112 and the S-GW 123 arranged in the EPC 120. The plurality of candidate core network entities may include the P-GW component 144 associated with the eNB 112 and the P-GW 124 arranged in the EPC 120. In general, the S-GW component 143 and the P-GW component 144 associated with the eNB 112 have smaller route costs and narrower management ranges than those of the S-GW 123 and the P-GW 124 arranged in the EPC 120, respectively.

A specific example of the selection of a core network user plane entity performed by the UE 111 is similar to that of the MME selection explained in the first embodiment, and therefore its explanation is omitted here.

In a block 903, the UE 111 transmits a request message for requesting the change of a core network entity. The UE 111 may transmit the change request message to the serving MME that is currently performing the mobility management for the UE 111 (e.g., the MME device 121). Alternatively, the UE 111 may transmit the change request message to the target core network entity selected in the block 902 (e.g., the S-GW component 143.).

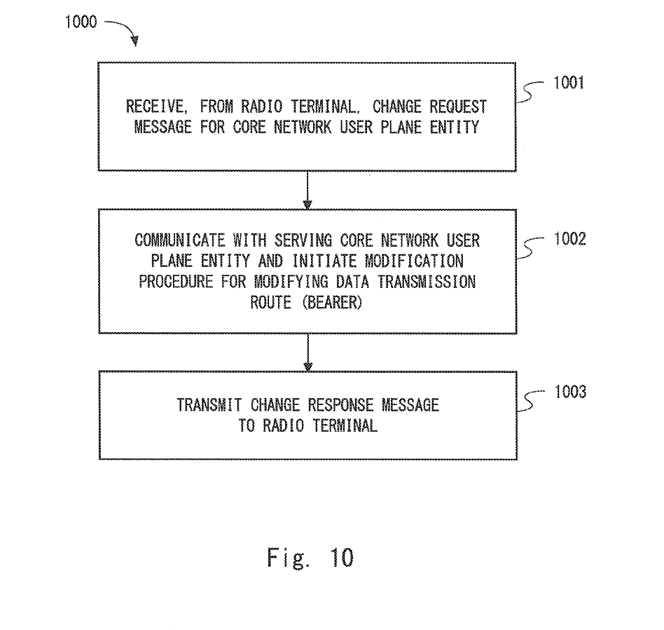

FIG. 10 is a flowchart showing a process 1000 that is an example of an operation that is performed by the serving MME when the serving MME receives a message requesting the change of the core network user plane entity. In a block 1000, the serving MME (e.g., the MME device 121 or the MME component 141) receives a message (change request message) for requesting the change of the core network user plane entity from the UE 111. In a block 1002, the serving MME communicates with a serving core network user plane entity that is currently performing a data transmission for the UE 111 (e.g., the serving S-GW) and starts a bearer modification procedure for modifying the data transmission route (i.e., an Evolved Packet System (EPS) bearer) of the UE 111 so that data passes through the target core network user plane entity determined by the UE 111. In a block 1003, upon completing the bearer modification procedure, the serving MME transmits a change response message to the UE 111.

According to this embodiment, the selection of the core network user plane entity that provides a data transmission service to the UE 111 is carried out in the UE 111. Therefore, in this embodiment, the selection of a core network user plane entity can be easily performed according to the dynamically changing state of the UE 111 (e.g., the delay tolerance level, the mobility characteristic, the occurrence frequency of signaling, or the communication interval).

Further, in the control procedure explained in this embodiment, the UE 111 operates to receive the policy for selecting a core network user plane entity from the network (e.g., the MME device 121). Therefore, the selection policy can be determined in the network, thus making it possible to set a selection policy that is determined according to the state of the network (e.g., the load on the MME and the occurrence/non-occurrence of congestion) in the UE 111.

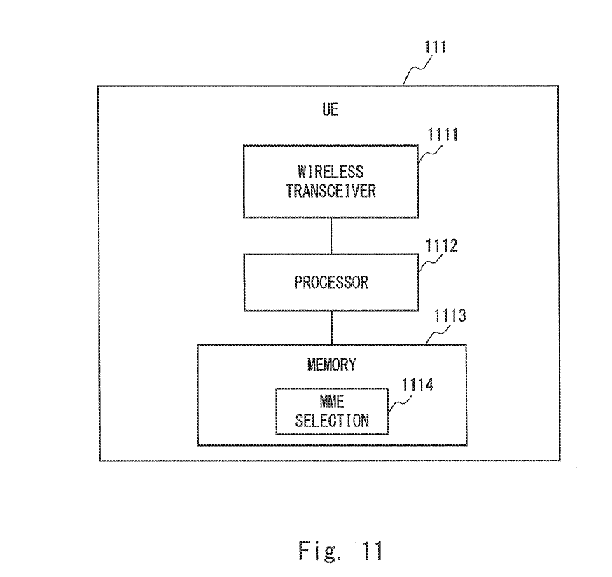

Finally, configuration examples of the UE 111, the MME device 121, the MME component 141, and the MME component 142 according to the above-described first to fourth embodiments are explained. FIG. 11 shows a configuration example of the UE 111 according to the first to third embodiments. The UE 111 according to the fourth embodiment (i.e., the UE 111 that performs the selection of a core network user plane entity) may have a configuration similar to that shown in FIG. 11. Referring to FIG. 11, the UE 111 includes a radio transceiver 1111, a processor 1112, and a memory 1113. The radio transceiver 1111 is configured to communicate with the E-UTRAN 110 (eNB 112).

The processor 1112 loads and executes software (computer program) stored in the memory 1113, and thus performs a process(s) of the UE 111 related to the process 200, 400 or 600 explained in the above-described embodiments. The processor 1112 may be, for example, a microprocessor, a Micro Processing Unit (MPU), or a Central Processing Unit (CPU). The processor 1112 may include a plurality of processors.

The memory 1113 includes a volatile memory and a nonvolatile memory. The volatile memory is, for example, a Static Random Access Memory (SRAM), a Dynamic RAM (DRAM), or a combination of them. The nonvolatile memory is, for example, a Mask Read Only Memory (MROM), a Programmable ROM (PROM), a flash memory, a hard disk drive, or any combination of them. The memory 1113 may include a storage that is remotely arranged from the processor 1112. In this case, the processor 1112 may access the memory 1113 through an I/O interface (not shown).

In the example shown in FIG. 11, the memory 1113 is used to store software modules including an MME selection module 1114. The MME selection module 1114 includes instructions and data necessary for performing a process(es) of the UE 111 related to the process 200, 400 or 600 explained in the above-described embodiments. The processor 1112 loads and executes software modules including the MME selection module 1114 stored in the memory 1113, and thus can perform processes of the UE 111 explained in the above-described embodiments.

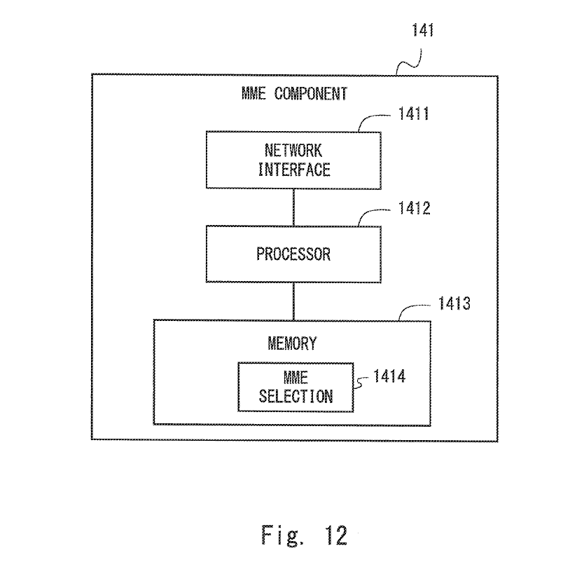

FIG. 12 shows a configuration example of the MME component 141 according to the first to third embodiments. The MME device 121 and the MME component 142 according to the first to third embodiments may have a configuration similar to that shown in FIG. 12. The MME device 121 according to the fourth embodiment (i.e., the MME device 121 that assists the selection of a core network user plane entity) may have a configuration similar to that shown in FIG. 12. Referring to FIG. 12, the MME component 141 includes a network interface 1411, a processor 1412, and a memory 1413. The network interface 1411 is used to communicate with a network node(s) (e.g., the MME device 121, the HSS 122, and the S-GW 123). The network interface 1411 may include, for example, a Network Interface Card (NIC) in conformity with the IEEE 802.3 series.

The processor 1412 loads and executes software (computer program) stored in the memory 1413, and thus performs a process(s) of the MME component 141 related to the process 300, 400, 500, 600 or 700 explained in the above-described embodiments. The processor 1412 may be, for example, a microprocessor, an MPU, or a CPU. The processor 1412 may include a plurality of processors.

The memory 1413 includes a volatile memory and a nonvolatile memory. The volatile memory is, for example, an SRAM, a DRAM, or a combination of them. The nonvolatile memory is, for example, an MROM, a PROM, a flash memory, a hard disk drive, or any combination of them. The memory 1413 may include a storage that is remotely arranged from the processor 1412. In this case, the processor 1412 may access the memory 1413 through the network interface 1411 or another I/O interface (not shown).

In the example shown in FIG. 12, the memory 1413 is used to store software modules including an MME selection module 1414. The MME selection module 1414 includes instructions and data necessary for performing a process(s) of the MME component 141 related to the process 300, 400, 500, 600 or 700 explained in the above-described embodiments. The processor 1412 loads and executes software modules including the MME selection module 1414 stored in the memory 1413, and thus can perform processes of the MME component 141 explained in the above-described embodiments.

As explained above with reference to FIGS. 11 and 12, each of the processors included in the UE 111, the MME device 121, the MME component 141, and the MME component 142 according to the above-described embodiments executes one or more programs including instructions to cause a computer to perform an algorithm explained with reference to the drawings. This program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Compact Disc Read Only Memory), CD-R, CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

### Other Embodiments

Each of the above-described embodiments may be used individually, or two or more of the embodiments may be appropriately combined with one another.

In the above-described embodiments, at least one of the MME device 121, the MME component 141, and the MME component 142 may be a virtualized MME using a server virtualization technology and a network virtualization technology. The virtualized MME may be implemented as a virtual machine configured in a server pool or a virtual router configured in a physical switches.

The above-described embodiments are explained by using specific examples mainly related to the EPS. However, these embodiments may be applied to other mobile communication systems such as a UMTS (Universal Mobile Telecommunications System), a 3GPP2 CDMA2000 system (1xRTT, HRPD (High Rate Packet Data)), a GSM (Global System for Mobile communications)/GPRS (General packet radio service) system, and a mobile WiMAX system.

Further, the above-described embodiments are merely examples of applications of the technical ideas obtained by the inventor. Needless to say, these technical ideas are not limited to the above-described embodiments and various modifications can be made thereto.

The whole or part of the embodiments disclosed above can be described as, but not limited to, the following supplementary notes.

### (Supplementary Note 1)

A radio terminal including:

a memory; and

at least one processor coupled to the memory and configured to:
establish a control connection with a serving mobility management entity (MME) arranged in a network;
receive from the network a selection policy used for MME selection;
select a target MME based on the selection policy; and
transmit to the network a request message for requesting a transfer of mobility management for the radio terminal from the serving MME to the target MME.

### (Supplementary Note 2)

A network apparatus including:

a memory; and

at least one processor coupled to the memory and configured to:
receive from a radio terminal an MME change request that explicitly indicates the network apparatus determined as a target MME by the radio terminal; and
in response to the MME change request, communicate with a serving MME that is currently performing mobility management for the radio terminal, to take over the mobility management from the serving MME.

### (Supplementary Note 3)

A method performed by a radio terminal, including:

establishing a control connection with a serving mobility management entity (MME) arranged in a network;

receiving from the network a selection policy used for MME selection;

selecting a target MME based on the selection policy; and

transmitting to the network a request message for requesting a transfer of mobility management for the radio terminal from the serving MME to the target MME.

### (Supplementary Note 4)

A method performed by a network apparatus, including:

receiving from a radio terminal an MME change request that explicitly indicates the network apparatus determined as a target MME by the radio terminal; and

in response to the MME change request, communicating with a serving MME that is currently performing mobility management for the radio terminal, to take over the mobility management from the serving MME.

### (Supplementary Note 5)

A non-transitory computer readable medium storing a program for causing a computer to perform the method described in Supplementary Note 3.

### (Supplementary Note 6)

A non-transitory computer readable medium storing a program for causing a computer to perform the method described in Supplementary Note 4.

According to the above-described embodiments, it is possible, for example, to provide an apparatus, a method, and a program that make it easier to determine which of a plurality of core network entities should be used for a radio terminal according to a state of the radio terminal that dynamically changes.

1.-30. (canceled)

31. A network apparatus comprising:
a memory; and
at least one processor coupled to the memory and configured to:
receive from a radio terminal a change request for a core network entity, the change request explicitly indicating a target core network entity determined by the radio terminal; and
in response to the change request, communicate with a serving core network entity that is currently providing a mobility management service or a data transmission service for the radio terminal, to transfer the mobility management service or the data transmission service from the serving core network entity to the target core network entity.

32. The network apparatus according to claim 31, wherein the core network entity is a mobility management entity (MME) that provides a mobility management service.

33. The network apparatus according to claim 31, wherein the core network entity is a serving gateway (S-GW) or a packet data network gateway (P-GW) that provides a data transmission service.

34. A method performed by a network apparatus, comprising:
receiving from a radio terminal a change request for a core network entity, the change request explicitly indicating a target core network entity determined by the radio terminal; and
in response to the change request, communicating with a serving core network entity that is currently providing a mobility management service or a data transmission service for the radio terminal, to transfer the mobility management service or the data transmission service from the serving core network entity to the target core network entity.

35. The method according to claim 34, wherein the core network entity is a mobility management entity (MME) that provides a mobility management service.

36. The method according to claim 34, wherein the core network entity is a serving gateway (S-GW) or a packet data network gateway (P-GW) that provides a data transmission service.

37. A non-transitory computer readable medium storing a program for causing a computer to perform a method in a network apparatus,
wherein the method comprises:
receiving from a radio terminal a change request for a core network entity, the change request explicitly indicating a target core network entity determined by the radio terminal; and
in response to the change request, communicating with a serving core network entity that is currently providing a mobility management service or a data transmission service for the radio terminal, to transfer the mobility management service or the data transmission service from the serving core network entity to the target core network entity.
